(19) United States
(12) Patent Application Publication
(10) Pub. No.: US 2009/0211423 A1
(43) Pub. Date: Aug. 27, 2009

(54) Film cutter

(76) Inventors: Tadashi Kiyono, Saitama (JP); Ryo Yoshioka, Kyoto (JP)

Correspondence Address: CLARK & BRODY, 1090 VERMONT AVENUE, NW, SUITE 250, WASHINGTON, DC, 20005, US

(21) Appl. No.: 12/320,748

(22) Filed: Feb. 4, 2009

(30) Foreign Application Priority Data
Feb. 5, 2008 (JP) 2008-024663

(51) Int. Cl. B26D 1/10; B26D 1/34

(52) U.S. Cl. 83/747; 83/436.3; 83/651

(57) ABSTRACT

An improvement applicable to a laminate film cutter for cutting a thin film covering a planar body having plural partly overlapping short plates, the shape of the knife being a rectangular blade extending to a sharp cutting point, and the position of the knife being inclined downward in a controlled manner to prevent stalling of the feeder during cutting.

### FIELD OF THE INVENTION

This invention relates to an improvement applicable to a film cutter employable especially for production of a laminator or the like. In this specification, a laminator is defined as a laminated plate employable for production of a name-tag, certificate, passport, license certificate or the like. In other words, the laminator is a laminated plate made by laminating a transparent plate on a paper or the like on which letters and/or pictures are printed or written.

### BACKGROUND OF THE INVENTION

A description of a film cutter available in the prior art will be given below, referring to FIGS. 1 and 2 respectively showing the side view and the plan view thereof.

Referring to FIGS. 1 and 2, the film cutter (un-numbered) comprises two sets of roller type feeder means (7) for feeding a long planar plate covered by transparent plastic sheet (4) in the direction shown by an arrow (D), a traverse means (8) for traversing a knife (10) made of a thin, narrow and plane rectangular planar blade which is placed along the top surface of the long planar plate covered by transparent plastic sheet (4) to be inserted between the ends (1a) and (1b) of the neighboring quadrilateral plates (1) for the final purpose to cut the transparent plastic sheet (3) along the end (1b) of the upper one of the quadrilateral plates (1) and to produce a unit of lamination of a transparent plastic sheet (3) and a quadrilateral plate (1), the unit further representing each unit of the letters and/or pictures printed or written on the quadrilateral plate.

The cutting process to be conducted by using the film cutter available in the prior art will be described below. At the beginning, the production process of the material film lamination to be used for the cutting process will be described below, referring to FIGS. 3 through 6. FIGS. 3 and 4 respectively show the side view and the plan view of a long planar plate (2) which is a series of plural quadrilateral plates (1) standing on different levels with their ends overlapped. Small areas (1aa) and (1bb), each of which is close, respectively, to one of the ends (1a) and (1b) of the quadrilateral plate (1) such as paper or the like having a size of A-4, just for example, on which letters and/or pictures are printed or written, overlap resulting in the long planar plate (2).

Noted at this step for production of the long planar plate (2) is that each end (1a) of the quadrilateral plate (1) overlaps respective end (1b) of the quadrilateral plate (1), and that the small area (1aa) close to the end (1a) is not adhered to the small area (1bb) close to the end (1b). As a result, an extremely thin slit which will be referred to as (1d) remains between the small area (1aa) and the small area (1bb) to allow a knife (10) to be inserted therein or between the upper and lower quadrilateral plates (1).

FIGS. 5 and 6 respectively show the side view and the plan view of a long planar plate laminated by a transparent plastic sheet (4).

Referring to FIGS. 5 and 6, the next step is to cover the long planar plates (2) with a transparent plastic sheet (3) which is made from polyethylene terephthalate, oriented polypropylene or the like and has a width shorter than the width of the long planar plates (2), resultantly making a long planar plate laminated by a transparent plastic sheet (4).

The reason why the width of the transparent plastic sheet (3) must be shorter than that of the planar plate (2) is to enable the knife (10) to pass through the very thin slit (1d) remaining between the small areas (1aa) and (1bb) of the quadrilateral plates (1).

Noted at this step is that an adhesive is applied on the rear surface of the transparent plastic sheet (3). As a result, the plural quadrilateral plates (1) are adhered, or stuck, to the rear surface of the single transparent plastic sheet (3). It is important that the small area (1aa) close to the end (1a) of quadrilateral plates (1) and the small area (1bb) close to the end (1b) are piled to each other (i.e., overlap), an extremely thin slit (1d) does not touch the rear surface of quadrilateral plates (1) on which an adhesive is applied, so that the extremely thin slit (1d) is remained non-adhered between the small area (1aa) and the small area (1bb) to allow the knife (10) to be inserted between the upper quadrilateral plate (1) and the lower quadrilateral plate (1) for cutting the transparent plastic sheet (3) at a point close to the end (1b) of the upper one of the quadrilateral plates (1).

The final step to be described referring to FIGS. 1 and 2 is that the transparent plastic sheet (3) is cut at each location where the ends (1a) and (1b) of the neighboring quadrilateral plates (1) overlap. In other words, the final step is to separate each unit from the laminated transparent plastic sheet (4).

Referring to FIGS. 1 and 2 again, the purpose of the film cutter available in the prior art is to separate each unit of letters and/or pictures printed or written on the continued quadrilateral plates (1) and protected by a single transparent long plastic sheet (3). The film cutter has 2 sets of roller type feeder means (7) having a function to feed the long planar plate laminated by transparent plastic sheet (4) in the direction shown by an arrow (D), and a traverse means (8) for traversing a knife (10) across the long planar plate laminated by transparent plastic sheet (4).

Noted at this step is that an extremely thin slit (1d) exists between the small area (1bb) of the end (1b) of the upper quadrilateral plates (1) and the small area (1aa) of the end (1a) of the lower quadrilateral plates (1). Further noted is that the width of the transparent long plastic sheet (3) is required to be shorter than the width of the quadrilateral plates (1) to facilitate insertion of the knife (10) in the extremely thin slit (1d) between the ends (1a) and (1b) of the quadrilateral plates (1).

Due to the aforementioned parameters, the knife (10) can be inserted between the ends (1a) and (1b) of the neighboring quadrilateral plates (1) and cut the transparent plastic sheet (3) across the entire width of the transparent plastic sheet (3) to separate individual units of plural lamination of a transparent plastic sheet (3) and the quadrilateral plate (1), the unit representing each unit of the letters and/or pictures printed or written on the long planar plates (2).

### DRAWBACKS TO BE REMOVED BY THIS INVENTION

Since the film cutter available in the prior art described above uses a plane rectangular knife (10) arranged along the top surface of the long planar plates (2), the following drawbacks are inevitable.

The first one of the drawbacks is that because it is difficult to insert the knife (10) in the extremely thin slit (1d) between the small area (1bb) of the end (1b) of the upper piece of the quadrilateral plate (1) and the small area (1aa) of the end (1a) of the lower piece of the quadrilateral plates (1) (See FIG. 3.), it is necessary equip the cutter with additional means to push downward the lateral edge of the lower piece of the quadrilateral plate (1) and to push upward the lateral edge of the upper piece of the quadrilateral plate (1). The inefficiency of using the additional means is clear.

In addition, the equipment used for the foregoing purpose available in the prior art does not necessarily achieve the objective.

### OBJECTS OF THIS INVENTION

The object of this invention is to provide a film cutter free from the drawbacks elaborated above.

Incidentally, additional objects are elimination of the labor required for operation of the foregoing auxiliary tools effective to push downward the edges of the lower piece of the quadrilateral plate (1) and to push upward the edges of the upper piece of the quadrilateral plate (1)

### SUMMARY OF THE INVENTION

The first mode of improvement applicable to this film cutter relates to the shape (configuration) of the knife.

The first feature in the first mode of improvement applicable to the shape of the knife (6) is to make the general shape of the knife that of a rectangle that is longer in its length, narrower in its width, thinner in its thickness that has a sharp, pointed end, as illustrated in FIG. 7. A two-stage reduction of the width toward the pointed end as shown in FIG. 7 is preferable. The preferable thickness of the knife (6) is 0.3 mm. The preferable magnitude of the inner angle (14) of the point of the knife (6) is in the range of about 70 degrees through 110 degrees, as shown in FIG. 7. In a preferred embodiment, the width of the knife (6) is about 60 mm and the overall length is about 160 mm.

The second feature in the first mode of improvement applicable to the shape of the knife (6) is to make the cross-section of the knife (6) in a V-shape or convex when viewed from the bottom of the knife (6) (i.e., convex to the film) as shown in FIG. 8. The magnitude of the angle (5) between the two parts of the knife is in the range of about 90 degrees to about 170 degrees.

The second mode of improvement applicable to this film cutter is an inclined orientation of the knife (6).

The first feature in the second mode of improvement applicable to the position of the knife (6) is a downward inclination of the knife (6), wherein the cutting point is lower in the upstream direction with regard to the direction of movement D, as shown in FIG. 9. The preferable angle of inclination of the knife (6) relative to the long plastic sheet (3) is between about 2 degrees and about 16 degrees.

It is noted that when the angle of the downward inclination is small, no particular auxiliary equipment is required. When the angle of the downward inclination is relatively larger, however, equipment described below is required.

The second feature in the second mode of improvement is application of a downward inclination of the knife (6), wherein the initial amount of inclination is selected at a small amount e.g. 2 degrees and the inclination is gradually increased and the cutting point of the knife (6) advances downward to keep the height of the cutting point at the initial height, regardless the progress of the feeder (7) and traverse.

In this case, the maximum amount of inclination can be selected from the foregoing range of about 2 degrees and about 16 degrees.

As was referred to above, application of equipment for regulating the magnitude of the inclination of the downward inclination of the knife (6), for the purpose to keep unchanged the height at which the knife (6) contacts the extremely thin slit (1d), despite the location where the knife (6) contacts the extremely thin slit (1d) moves by the function of the feeder means (7).

The experimental results have proven downward inclination of the knife (6) is effective to enhance the various advantageous results. Particularly noted is that the downward inclination of the knife (6) is effective to simplify the handling of insertion of the knife (6) into the extremely thin slit (1d) left between the upper one of the quadrilateral plates (1) and the lower one of the quadrilateral plates (1) and to make the resultant cut end much more attractive.

It is noted that the foregoing items effective to cause the advantageous results can be employed either alone or in combination, and a combined employment causes much better results.

### BRIEF DESCRIPTION OF THE DRAWINGS

FIG. 1 is a side view of a film cutter available in the prior art.

FIG. 2 is a plan view of a film cutter available in the prior art.

FIG. 3 is a side view of a long planar plate produced by piling a plate above another in succession, available in the prior art and of this invention.

FIG. 4 is a plan view of a long planar plate produced by piling a plate above another in succession, available in the prior art and of this invention.

FIG. 5 is a side view of a long planar plate laminated by a transparent plastic sheet, available in the prior art and of this invention.

FIG. 6 is a plan view of a long planar plate laminated by a transparent plastic sheet, available in the prior art and of this invention.

FIG. 7 is a plan view of a knife employed for this invention.

FIG. 8 is a cross-section of a knife employed for this invention taken along line 8-8 of FIG. 7.

FIG. 9 is a side view of a film cutter of the second mode of improvement applied to this invention.

FIG. 10 is a plan view of a film cutter of the second mode of improvement applied to this invention.

FIG. 11 is a side view of a means for regulating the inclination of the knife in response to the progress of the feeder means of this invention.

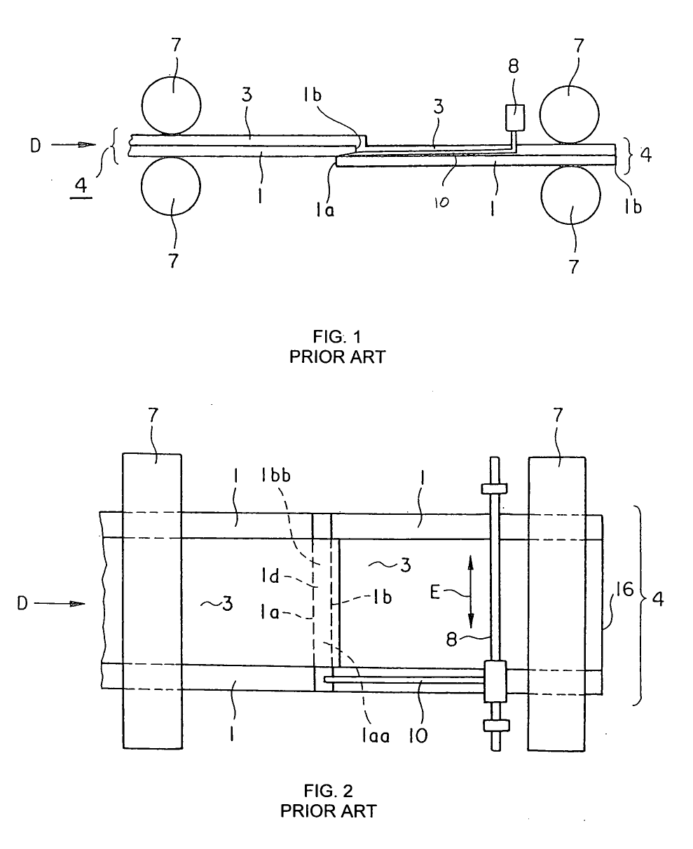

### BEST MODES IMPLEMENTING THIS INVENTION

Referring to drawings, several embodiments of this invention will be described below.

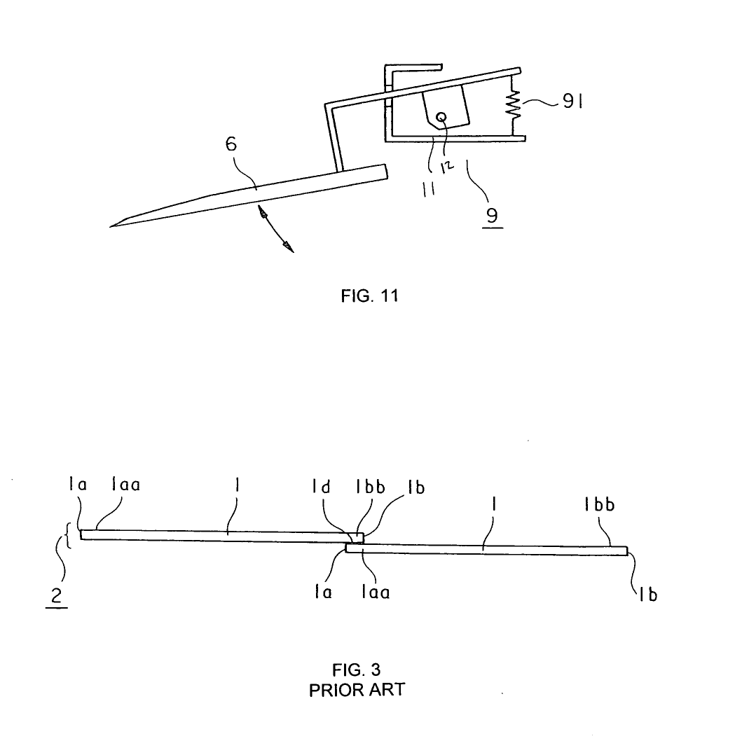

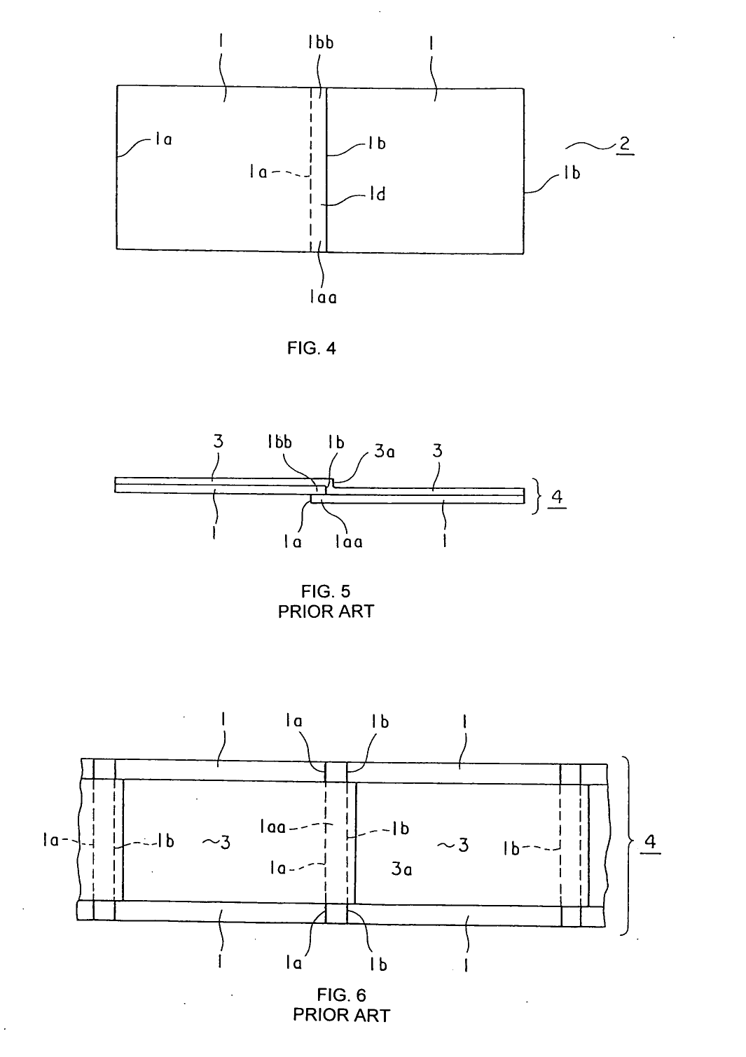

FIGS. 3 and 4 respectively show the side view and the plan view of a long planar plate (2) which is a series of overlapping quadrilateral plates (1) produced by overlapping one plate with a succeeding plate in succession. The long planar plate (2) is employed as a material plate for production of a laminator which is further a material plate for production of a name tag, certificate, passport, license plate or the like. The quadrilateral plates (1) are of uniform size and each bears letters and/or pictures printed or written thereon. Since the long planar plate (2) is entirely identical to that employed in the prior art, any further description is unnecessary.

FIGS. 5 and 6 respectively show the side view and the plan view of a long planar plate laminated by a transparent plastic sheet (4). This long planar plate laminated by a transparent plastic sheet (4) is a lamination made by covering the foregoing long planar plate (2) with a transparent long plastic sheet (3), which is preferably made from polyethylene terephthalate, oriented polypropylene or the like. Important is that the width of the transparent long plastic sheet (3) is less than that of the long planar plates laminated by a transparent plastic sheet (2) and the single transparent long plastic sheet (3) is adhered to plural quadrilateral plates (1). Since the long planar plate laminated by a transparent plastic sheet (4) is entirely identical to that of the prior art, any further description is unnecessary.

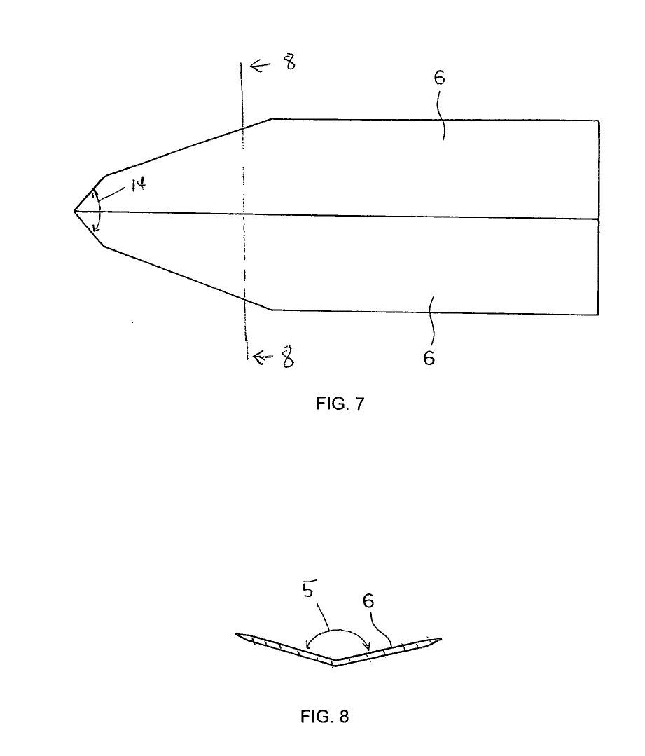

FIGS. 7 and 8 respectively show the plan view and the cross section of a knife (6) created just for this invention. In the drawings, the body thereof shown in the right portion of FIG. 7 is of uniform width which is made gradually smaller to reach the sharp cutting point shown in the left portion of the same drawing. The two-step reduction in width has shown advantageous experimental results. The preferable thickness of the knife (6) is about 0.3 mm. The preferable dihedral angle (5) of the V-shaped knife (6) is in the range of about 90 through 170 degrees.

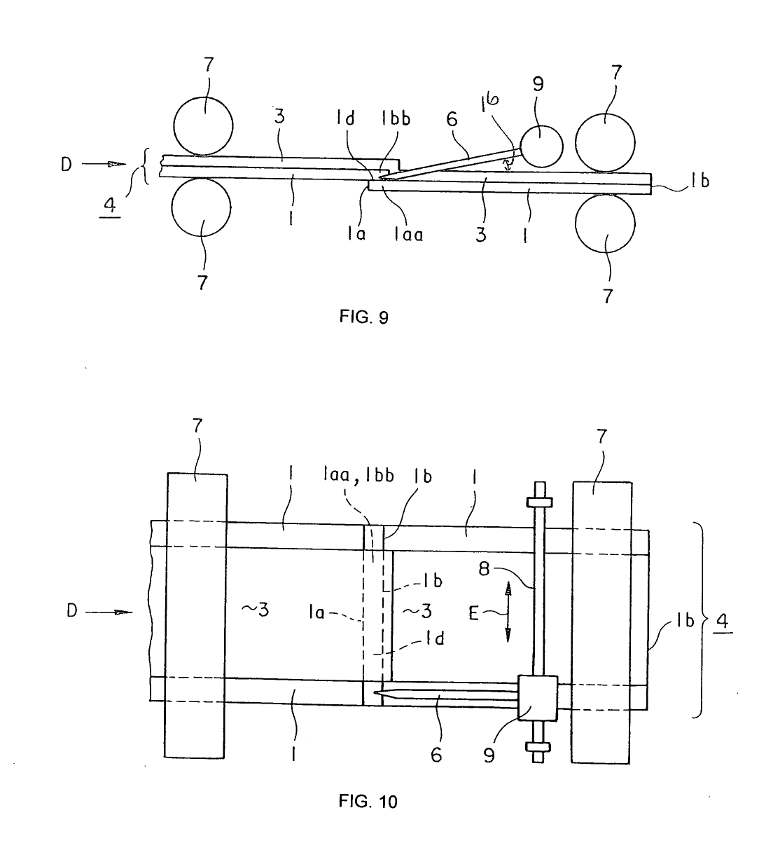

FIGS. 9 and 10 respectively is a side view and a plan view of a film cutter of the second mode of improvement applied to this invention. The knife (6) is arranged in a downwardly inclined position, keeping the point at a lowest position, as shown in FIG. 9. The angle of inclination (16) is illustrated in FIG. 9.

Referring to FIGS. 9 and 10, the film cutter (un-numbered) comprises two sets of roller type feed means (7) having a function to feed the long planar plate laminated by transparent plastic sheet (4) in the direction shown by an arrow (D), a traverse means (8) for traversing a knife (6) which is inserted between the ends (1a) and (1b) of the neighboring quadrilateral plates (1) for the final purpose to cut the transparent plastic sheet (3) and to produce individual units of lamination of a transparent long plastic sheet (3) and the quadrilateral plate (1) which is equivalent to units of the letters and/or pictures printed on the quadrilateral plates (1).

As discussed in SUMMARY OF THE INVENTION, the embodiment shown in FIGS. 9 and 10 realizes a remarkable advantage in the convenience of inserting the knife (6) between the ends (1a) and (1b) of the neighboring quadrilateral plates (1). In those cases where a large angle (16) of downward inclination is selected, a drawback arises wherein the height at which the cutting is actually occurs gradually increases, or moves upward, following the traverse process of the knife (6). In addition, the feeder means typically continues advancing the long planar plate as the knife traverses the long planar plate (2) in the cutting operation. Thus, when the knife is angled with respect to the long planar plate (2), the moving planar plate will push against the angled knife and potentially stall the movement of the plate, thus adversely affecting the cutting operation.

The second feature of the second mode of improvement applied to this invention is, however, effective to overcome the foregoing drawbacks.

FIG. 11 illustrates a means (9) for controlling the angle of inclination of the knife (6), for maintaining the height at which the knife (6) contacts the extremely thin slit (1d) fixed, despite the fact that the location where the knife (6) contacts the extremely thin slit (1d) moves because of the function of the feeder means (7). Moreover, allowing the angle of inclination to increase effectives prevents stalling engagement between the long planar plate and the knife.

Referring to FIG. 11, means (9) automatically regulates the downward inclination of the knife (6), to maintain the vertical position at which the knife (6) contacts the extremely thin slit (1d), regardless the progress of the long planar plate covered by transparent plastic sheet (4) driven by the feeder means (7) in the direction D. Since the location where the knife (6) contacts the extremely thin slit (1d) is the location where the cutting activity is realized, the height at which the knife (6) contacts the extremely thin slit (1d) is automatically regulated at a predetermined height. Regardless of the progress of the long planar plate covered by transparent plastic sheet (4) driven by the feeder means (7), the cutting activity is not disturbed, despite the fact that the cutting location moves in the direction of the arrow D. As well, the feeder means is not jammed by engagement between the advancing long planar plate and the angled knife.

The function of the means (9) is to balance of the weight of the knife (6) and the strength of a spring (91) for maintaining unchanged the height at which the knife (6) contacts the extremely thin slit (1d), by increasing the downward inclination of the knife (6). This function is realized by balancing the knife (6) by employment of a spring (91).

Though the location of the extremely thin slit (1d) moves to the right in FIG. 9 by the activity of the feeder means (7), since the height of the location of the extremely thin slit (1d) is maintained unchanged, it is clear that the traversing activity receives no disturbance. As a result, the paper cutting activity does not receive any disturbance.

The principle of the means 9 for regulating the inclination of the knife 6 in the embodiment shown is that the spring 91 will allow the cutting point of knife 6 engaged with the thin slit 1d between the ends 1bb and 1aa to move downward as the laminate 4 moves forward in the direction D. Thus, the inclination of the knife 6 automatically adjusts for relative movement between laminate 4 and knife 6 resulting in the inclination of the knife 6 increasing during progress of the traverse, but the height of the engagement between the knife and the transparent sheet 3 remains constant.

FIG. 11 shows a side view of a means 9 in accordance with a preferred embodiment of the invention for regulating the inclination of the knife 6. In this embodiment, the traverse means 8 includes a transversely movable knife support 11, which is driven across the laminate 4 during cutting by known drive means, which is not illustrated. The knife 6 is pivotally mounted to the support 11, as by a pivot axle 12, whereby the angle of inclination of the knife is adjustable. In the embodiment shown in FIG. 11, the inclination of the knife with respect to the support 11 and, in turn, the laminate 4 is controlled by spring 91, but other mechanisms for controlling the angle of inclination may be used.

As a result, the advantage of a large magnitude of downward inclination is allowed to be enjoyed, without receiving any adverse effects.

The foregoing description has clarified that this invention has successfully provided a film cutter which entirely satisfies the foregoing objects of this invention. Modifications within the scope of the appended claims will be apparent to those of skill in the art.

We claim:

1. A film cutter comprising:
a set of feeder means (7) for feeding a planar body comprising plural short plates partly overlapping, said planar body being covered by a transparent sheet (4),
a knife (6) having a rectangular blade extending to a sharp cutting point, said knife (6) being placed at an angle to the top surface of the lower level of said planar body, said knife (6) being configured to be inserted in a thin slit (1d) made between the upper level and the lower level of said planar body, said knife (6) being traversed by a traverse means (8) to cut said transparent sheet (4) along a linear portion connecting said overlapped plural short plates, and
means (9) for regulating said angle in response to the progress made by said feeder means (7).

2. A film cutter comprising:
a set of feeder means (7) for feeding a planar body comprising plural short plates partly overlapping, said planar body being covered by a transparent sheet (4),
a knife (6) having a rectangular blade extending to a sharp cutting point, said knife (6) being placed in a downward inclined position on the top surface of the lower level of said overlapped planar body, said knife (6) being to be inserted in a thin slit (1d) made between the upper level and the lower level of said overlapped planar body, said knife (6) being traversed by a traverse means (8) to cut said transparent sheet (4) along a linear portion connecting said overlapped plural short plates.

3. A film cutter in accordance with claim 2, further comprising a means (9) for regulating the magnitude of the inclination of said downward inclined position in response to the progress made by said feeder means (7).

4. A film cutter in accordance with claim 2 wherein the magnitude of the angle of said sharp cutting point knife (6) is in the range of 70 degrees through 110 degrees.

5. A film cutter in accordance with claim 2 wherein said knife (6) has a V-shaped cross-section.

6. A film cutter in accordance with claim 2 wherein the thickness of said knife (6) is approximately 0.3 mm.

7. A film cutter in accordance with claim 6 wherein the internal angle of the V-shaped knife ranges between 90 degrees and 170 degrees.

8. A film cutter in accordance with claim 3, wherein the magnitude of said downward inclination is selected to be approximately 10 degrees for the starting period, and selected from the approximate range of 10 degrees through 16 degrees thereafter.
